(19) United States
(12) Patent Application Publication
(10) Pub. No.: US 2021/0323076 A1
(43) Pub. Date: Oct. 21, 2021

(54) Air chuck Capable of Quickly Clamping Threaded Valve

(71) Applicant: Chengdu King-key Machine Manufacturing Co., Ltd., Chengdu (CN)

(72) Inventor: Zeqi Lei, Chengdu (CN)

(73) Assignee: Chengdu King-key Machine Manufacturing Co., Ltd.

(21) Appl. No.: 17/364,865

(22) Filed: Jun. 30, 2021

(51) Int. Cl. B23B 31/12; B23B 31/30

(52) U.S. Cl. CPC B23B 31/1223; B23B 31/1215; B23B 31/30

(57) ABSTRACT

An air chuck capable of quickly clamping a threaded valve comprises a chuck body (1). An air passage is formed in the chuck body (1). The chuck body (1) has one end connected to an elastic clamping jaw (5) and the other end connected to an air source. Jaw arms (52) are regularly disposed at a front end of the clamping jaw (5). Jaw teeth (51) in contact with a threaded valve are disposed at front ends of the jaw arms (52) and are multiple internal thread teeth that of the same specification as an external thread of the valve to be clamped. A sliding sleeve (4) is disposed around the chuck body (1) and slides to control the clamping jaw (5) to be opened or closed in a radial direction.

### BACKGROUND OF THE INVENTION

### 1. Technical Field

The invention relates to the technical field of air chucks, in particular to an air chuck capable of quickly clamping a threaded valve.

### 2. Description of Related Art

As is commonly known, tires are one of the critical components of vehicles, and quick air chucks for fluid transmission are connected to threaded valves of the tires for inflating the tires. Existing common quick air chucks are of a lever-type. Although such chucks are convenient to use, these chucks may sometimes fail to be reliably connected to the threaded valves due to the limitation of the single-side clamped and stressed structure and the fabrication precision, which in turn leads to air leakages and even separation from the threaded valves. Sheet multi jaw quick air chucks provided with a sliding sleeve are used to reduce air leakages during connection; however, due to the limitation of the rigidity of an axial stop structure and a sheet of such chucks, clamping jaws cannot clamp the threaded valve more deeply, which will reduce the connection airtightness in presence of an axial external force and fail to realize normal clamping in some narrow spaces.

### BRIEF SUMMARY OF THE INVENTION

The invention aims to solve the problems in the prior art that the lever-type quick air chucks may cause air leakages and even be detached due to infirm connection with threaded valves and the multi-jaw quick air chucks provided with a sliding sleeve cannot realize normal clamping when used in some narrow spaces.

To overcome the defects of the prior art, the objective of the invention is to provide an air chuck capable of quickly clamping a threaded valve.

To fulfill the above objective, the invention adopts the following technical solution:

An air chuck capable of quickly clamping a threaded valve comprises a multi-step cylindrical chuck body, wherein an air passage is formed in the chuck body, the chuck body has one end tapped with an external thread connected to a clamping jaw and the other end connected to an air source, an internal threaded hole connected to the chuck body is formed in a rear end of the clamping jaw, the clamping jaw is provided with a plurality of jaw arms that are regularly distributed, front ends of the jaw arms stretch outwards and are provided with jaw teeth for cooperatively clamping a threaded valve, the specification of the jaw teeth is the same as that of the threaded valve to be connected, a sliding sleeve capable of sliding forwards and backwards in an axial direction of the chuck body is disposed around the chuck body, and steps are disposed on an outer circle of a front end of the clamping jaw to prevent the sliding sleeve from sliding out of a head of the clamping jaw.

Furthermore, the jaw teeth are multiple internal thread teeth that are of the same specification as the threaded valve clamped by the jaw teeth.

Furthermore, a seal washer in seal connection with the threaded valve to be connected is disposed on a front face of the chuck body.

Furthermore, an elastic retainer ring is disposed on an inner side of the front end of the clamping jaw to assist in stretching the jaw arms.

Furthermore, parts of an outer edge of a bottom ring extend in an axial direction to form the clamping jaw.

Furthermore, the clamping jaw is provided with at least two jaw arms that are regularly disposed on the bottom ring.

Furthermore, a normally-closed standard valve core or a normally-open tappet valve core is disposed in the air passage of the chuck body.

Furthermore, an internal thread to be connected to an air source chuck is tapped on an inner hole in the other end of the chuck body.

By adoption of the above solution, the sliding sleeve slides to control the clamping jaw to be opened or closed to realize quick and reliable connection; the clamping jaw is provided with the jaw arms capable of realizing symmetrical or uniform clamping, so that the threaded valve can be firmly clamped by the clamping jaw and will not leak air or be detached; the jaw teeth are multiple internal thread teeth that are of the same specification as an external thread of the threaded valve, so that a stop structure for reducing the deformation of the clamping jaw when the clamping jaw is stressed in the axial direction is not needed, the structure is more compact, the connected thread may be shorter and may be firmly clamped even if by an incomplete thread tooth at the front end of the thread, and thus, the air chuck can still be used in a narrow space and is wider in application range, simple in structure, easy to operate and high in practicability.

### BRIEF DESCRIPTION OF THE SEVERAL VIEWS OF THE DRAWINGS

FIG. 1 is an axonometric assembly diagram of an air chuck capable of quickly clamping a threaded valve according to the invention.

FIG. 2 is a sectional view of the air chuck capable of quickly clamping a threaded valve according to the invention.

FIG. 3 is an axonometric diagram of a clamping jaw of the air chuck capable of quickly clamping a threaded valve according to the invention.

FIG. 4 is a schematic diagram of the clamping jaw of the air chuck capable of quickly clamping a threaded valve when the clamping jaw releases the threaded valve according to the invention.

FIG. 5 is a schematic diagram of the clamping jaw of the air chuck capable of quickly clamping a threaded valve when the clamping jaw clamps the threaded valve according to the invention.

In the figures:

1, chuck body; 2, elastic retainer ring; 3, seal ring; 4, sliding sleeve; 5, clamping jaw; 51, jaw teeth; 52, jaw arm; 53, internal threaded hole; 54, bottom ring.

### DETAILED DESCRIPTION OF THE INVENTION

The embodiments of the invention will be described in detail below in conjunction with the accompanying drawings. Clearly, the invention may be implemented in different manners defined and covered by the claims.

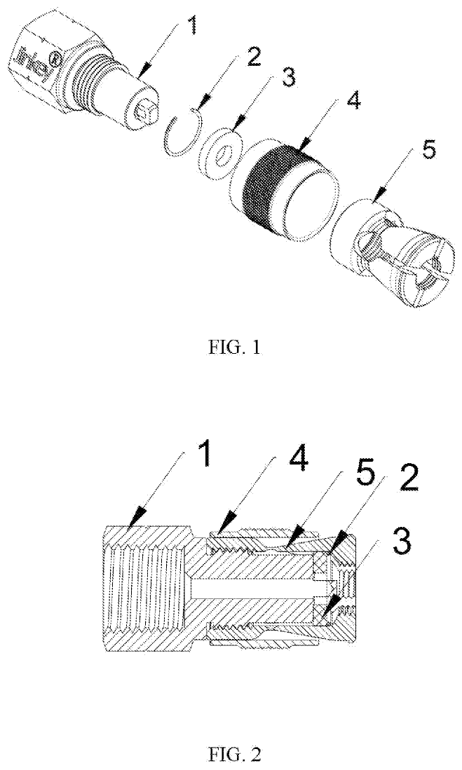

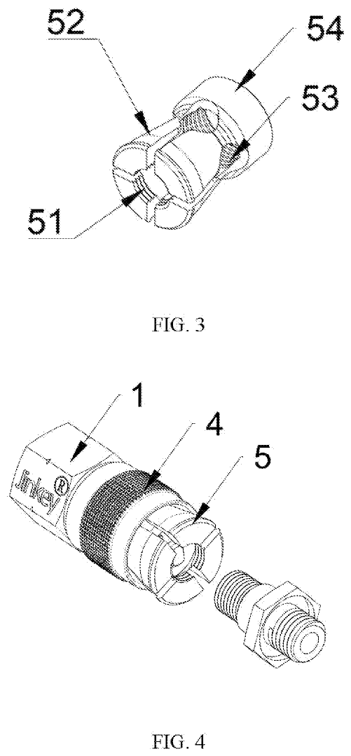

As shown in FIG. 1 to FIG. 5, this embodiment provides an air chuck capable of quickly clamping a threaded valve. The air chuck capable of quickly clamping a threaded valve comprises a multi-step cylindrical chuck body 1, wherein an air passage is formed in the chuck body 1, an external thread connected to a clamping jaw 5 is tapped at one end of the chuck body 1, the other end of the chuck body 1 is connected to an air source, an internal threaded hole 53 connected to the chuck body 1 is formed in a rear end of the clamping jaw 5, the clamping jaw 5 is provided with jaw arms 52, front ends of the jaw arms 52 stretch outwards and are provided with jaw teeth 51 for cooperatively clamping a threaded valve (not shown), the specification of the jaw teeth 51 is the same as that of the threaded valve to be connected, a sliding sleeve 4 capable of sliding forwards and backwards in an axial direction of the chuck body 1 is disposed around the chuck body 1, a hexahedron is disposed behind the chuck body 1, the dimension between opposite sides of the hexahedron is greater than the inner diameter of the sliding sleeve 4, steps are disposed at a front end of the clamping jaw 5, and the diameter of the steps is greater than the inner diameter of the sliding sleeve 4. In this way, the sliding sleeve 4 can be limited front and back when sliding forwards and backwards in the axial direction of the chuck body 1 after being disposed around the cylindrical chuck body 1.

Furthermore, in this embodiment, the jaw teeth 51 are multiple internal thread teeth which are of the same specification as an external thread of the threaded valve to be clamped. In this way, the connection rigidity is higher, the axial deformation is small, and the airtightness is improved; in addition, the connected thread may be shorter and may be clamped firmly even if by an incomplete thread tooth at the front end of the thread, and thus, the air chuck can still realize normal clamping when used in a narrow space.

Furthermore, in this embodiment, a seal washer 3 to be in seal connection with a lip of the valve to be connected is disposed on a front face of the chuck body 1, so that airtight connection is formed between the chuck body 1 and the threaded valve clamped in the clamping jaws 5.

Furthermore, in this embodiment, parts of an outer edge of a bottom ring 54 extend in an axial direction to form the clamping jaw 5, and an extending end of the clamping jaw 5 is a front end.

Furthermore, in this embodiment, the clamping jaw 5 is provided with at least two jaw arms 52 regularly disposed on the bottom ring 54, and the jaw arms 52 are disposed regularly to ensure that the connected thread is stressed uniformly and will not move in a radial direction, so that air leakages are avoided.

Furthermore, in this embodiment, the clamping jaw 5 is provided with an elastic retainer ring 2 located on inner sides of the jaw arms 52, so that the elasticity of the jaw arms 52 is further improved.

Furthermore, in this embodiment, the clamping jaw 5 is made of an elastic material such spring steel, or other materials. This embodiment has no specific limitation to the material used for making the clamping jaw 5.

Furthermore, in this embodiment, a normally-closed standard valve core or a normally-open tappet valve core is disposed in the air passage of the chuck body 1.

Furthermore, an internal thread to be connected to an air source chuck is tapped on an inner hole in the other end of the chuck body 1.

In one embodiment, different ports may be designed at the other end of the chuck body 1 according to different forms of chucks connected to this end of the chuck body 1.

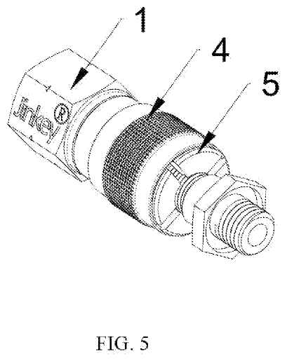

FIG. 4 and FIG. 5 illustrate the usage states of the air chuck capable of quickly clamping a threaded valve according to the invention. When the chuck body 1 abuts against the lip of the valve connected to the chuck body 1, airtight connection between the chuck body 1 and the valve is realized by means of the seal ring 3; at this moment, the sliding sleeve 4 is pushed to slide forwards, and the four jaw arms 52 are pressed by the sliding sleeve 4 to deform elastically to drive the four jaw teeth 51 to move synchronously in the radial direction to clamp the thread of the threaded valve. When the sliding sleeve 4 slides backwards, the jaw arms 52 restore to the original shape and drive the jaw teeth 51 to be separated from the thread of the threaded valve.

The above embodiments are merely preferred ones of the invention, and are not intended to limit the patent scope of the invention. All equivalent structural transformations or flow transformations obtained based on the contents of the specification and drawings of the invention, or direct or indirect applications to other relating technical fields should also fall within the protection scope of the patent of invention.

What is claimed is:

1. An air chuck capable of quickly clamping a threaded valve, comprising a multi-step cylindrical chuck body (1), wherein an air passage is formed in the chuck body (1), the chuck body (1) has an end tapped with an external thread connected to a clamping jaw (5) and an end connected to an air source, an internal threaded hole (53) connected to the chuck body (1) is formed in a rear end of the clamping jaw (5), a plurality of jaw arms (52) are disposed on an outer side of the clamping jaw (5), front ends of the jaw arms (52) stretch outwards and are provided with jaw teeth (51) for clamping a threaded valve, a specification of the jaw teeth (51) is the same as that of the threaded valve to be connected, and a sliding sleeve (4) capable of sliding forwards and backwards in an axial direction of the chuck body (1) is disposed around the chuck body (1); when sliding forwards, the sliding sleeve (4) uniformly compresses the jaw arms (52) to enable the jaw arms (52) to contract inwards to fit a clamped thread to realize firm connection; when the sliding sleeve (4) slides backwards, the compressed jaw arms (52) are released under an elastic force to enable the jaw teeth (51) to be completely separated from the threaded valve; and when the sliding sleeve (4) continues to move backwards to abut against a hexahedron of the chuck body (1), the clamping jaw (5) and the chuck body (1) are separated from the threaded valve, so that quick separation is realized.

2. The air chuck capable of quickly clamping a threaded valve according to claim 1, wherein the jaw teeth (51) are multiple internal thread teeth that are of a same specification as the threaded valve clamped by the jaw teeth (51).

3. The air chuck capable of quickly clamping a threaded valve according to claim 2, wherein a seal washer (3) in seal connection with the threaded valve is disposed on a front face of the chuck body (1).

4. The air chuck capable of quickly clamping a threaded valve according to claim 3, wherein an elastic retainer ring (2) is disposed on an inner side of the clamping jaw (5) to improve an elasticity of the jaw arms (52).

5. The air chuck capable of quickly clamping a threaded valve according to claim 4, wherein parts of an outer edge of a bottom ring (54) extend in an axial direction to form the clamping jaw (5).

6. The air chuck capable of quickly clamping a threaded valve according to claim 5, wherein the clamping jaw (5) is provided with at least two jaw arms (52) that are regularly disposed on the bottom ring (54).

7. The air chuck capable of quickly clamping a threaded valve according to claim 6, wherein a normally-closed standard valve core or a normally-open tappet valve core is disposed in the air passage of the chuck body (1).

8. The air chuck capable of quickly clamping a threaded valve according to claim 7, wherein an internal thread to be connected to an air source chuck is tapped on an inner hole in the end, connected to the air source, of the chuck body (1).
